(19) United States
(12) Patent Application Publication
(10) Pub. No.: US 2003/0137760 A1
(43) Pub. Date: Jul. 24, 2003

(54) Scanner tuned optical add/drop filters

(76) Inventors: Catherine E. Cormack, Decatur, GA (US); Robert H. Cormack, Decatur, GA (US)

Correspondence Address: JENNIFER L. BALES, MOUNTAIN VIEW PLAZA, 1520 EUCLID CIRCLE, LAFAYETTE, CO, 80026-1250, US

(21) Appl. No.: 10/325,306

(22) Filed: Dec. 20, 2002

Related U.S. Application Data
(60) Provisional application No. 60/344,096, filed on Dec. 20, 2001.

(51) Int. Cl. G02B 5/22

(52) U.S. Cl. 359/889

(57) ABSTRACT

Apparatus and methods for tuning an optical filter system of the sort including a filter element which is tuned according the angle of incidence (AOI) of light incident on the filter element by changing the angle of incidence of the light beam incident on the filter element, rather than by rotating the filter element itself. A scan relay changes the angle of the beam incident upon the filter element. An add/drop filter utilizes two scan relays and several mirrors to add, drop, and pass signals without rotating the filter element.

This application claims the benefit of U.S. Provisional Patent Application No. 60/344,096, filed Dec. 20, 2001.

### BACKGROUND OF THE INVENTION

1. Field of the Invention

The present invention relates to apparatus and methods for tuning an optical filter by changing the angle of incidence of the light beam incident on the filter.

2. Description of the Prior Art

Certain optical filters (such as Fabre-Perot filters and thin-film interference filters) are tuned by changing the angle of incidence (AOI) of the input beam at the filter. Prior art AOI tuning methods and apparatus have required the filter itself to move in order to change the AOI and tune the filter to a particular frequency.

FIG. 1 (Prior Art) is a side view of a conventional scan relay device 100. Input beam 102 is incident upon scanning mirror 103. As scanning mirror 103 rotates about an axis perpendicular to input beam 102, resulting reflected beam 106 is transmitted at different angles. FIG. 1 shows two examples. Scanning mirror 103 position 104a (solid line) produces reflected beam 106a (solid line). Scanning mirror 103 position 104b (dotted line) produces reflected beam 106b (dotted line).

Relay lenses 108 and 110 focus beam 106a, 106b to form output beams 112a, 112b, respectively. All output beams pass through relayed scan point 114, but they pass through it at various angels, determined by the angle 104 of mirror 103.

A need remains in the art for apparatus and methods for tuning an optical filter by changing the angle of incidence of the light beam incident on the filter, rather than by rotating the filter itself.

### SUMMARY OF THE INVENTION

The present invention provides apparatus and methods for tuning an optical filter by changing the angle of incidence of the light beam incident on the filter, rather than by moving the filter itself. Further, it provides apparatus and methods for utilizing such tuning apparatus and methods to accomplish a tunable add/drop filter for use in wavelength-division multiplexed (WDM) optical networks.

A simple optical filter apparatus for selectively passing or reflecting an input optical signal includes a scan relay for selectively changing the angle of the input optical signal to form a scanned beam, and a filter element of the kind tuned according the angle of incidence (AOI) of light incident on the filter element, the filter element positioned to intercept the scanned beam. The filter element does not rotate with respect to the axis of the input signal.

The scan relay might comprise a rotating mirror positioned to intercept the input signal and two lenses positioned to pass the reflected beam. The filter element might be a thin film interference filter (TFF) or a Fabry-Perot filter. A detector for detecting any light transmitted by the filter element, and for generating an output signal based on detected light may be included.

An optical drop filter system of the type having an input port into which an input signal from a optical multiplexing system is transmitted, a pass port through which signals to be returned to the system, and a drop port, through which signals are removed from the system, includes a scan relay for selectively changing the angle of the input optical signal to form an input scanned beam, a filter element of the kind tuned according the angle of incidence (AOI) of light incident on the filter element, the filter element positioned to intercept the input scanned beam and to transmit the input scanned beam or reflect the input scanned beam according to the wavelength of the input scanned beam, and optics for directing any transmitted input scanned beam to the drop port. The first scan relay further directs the reflected input scanned beam to the pass port, and the filter element does not rotate with respect to the optical axis of the input signal.

An optical add/drop filter of the type having an input port into which an input signal from a optical multiplexing system is transmitted, a pass port through which signals to be returned to the system are transmitted, a drop port, through which signals are removed from the system, and an add port, via which an add signal is injected into the system, the add/drop filter comprises a first scan relay for selectively changing the angle of the input optical signal to form an input scanned beam, a filter element of the kind tuned according the angle of incidence (AOI) of light incident on the filter element, the filter element positioned to intercept the scanned beam and to transmit the input scanned beam or reflect the input scanned beam according to the wavelength of the input scanned beam, and a second scan relay for directing any transmitted input scanned beam to the drop port. The first scan relay directs any reflected input scanned beam to the pass port. The second scan relay selectively changes the angle of any add optical signal to form an add scanned beam. The filter transmits the add scanned beam according to its wavelength, and the first scan relay directs the transmitted add scanned beam to the pass port. Again, the filter element does not rotate with respect to the optical axis of the input signal.

In a particularly efficient embodiment of the present invention, the first scan relay and the second scan relay utilize the same optical elements. For example, the first scan relay and the second scan relay comprise two cylindrical scan lenses. Five mirrors are required to direct the beams. An array of filter panels may also be used, with an actuator selectively placing a filter array element in the path of the scanned beam.

### BRIEF DESCRIPTION OF THE DRAWINGS

FIG. 1 (Prior Art) is a side schematic view of a conventional optical scan relay.

FIG. 2 is a side schematic view of a tunable optical filter according to the present invention using the scan relay of FIG. 1.

FIG. 3 is a side schematic view of a tunable add/drop filter according to the present invention using the scan relay of FIG. 1.

FIG. 4 is a side ray trace view of the add/drop filter of FIG. 3 configured to provide a relatively low angle of incidence (AOI) at the filter element.

FIG. 5 is a side ray trace view of the add/drop filter of FIG. 3 configured to provide a relatively high AOI at the filter element.

FIG. 6a is an isometric drawing of a second preferred embodiment of an add/drop filter according to the present invention.

FIG. 6b is an isometric view of a variation on the embodiment of FIG. 6a wherein multiple filter elements are used in place of the single filter element of FIG. 6a.

### DETAILED DESCRIPTION OF THE PREFERRED EMBODIMENT

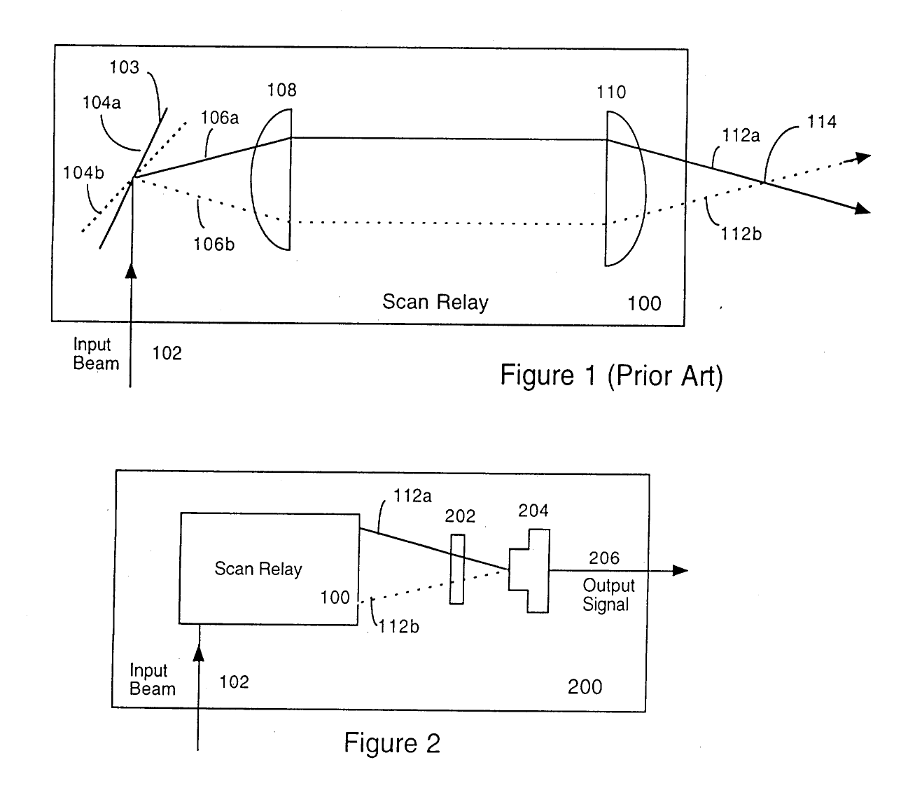

FIG. 2 is a side schematic view of a tunable optical filter 200 using the scan relay 100 of FIG. 1. Input beam 102 is provided to scan relay 100, which provides output beam 112 at a variety of angles, here angle 112a and 112b. Filter 202 is an optical filter which is tuned to a particular wavelength according to the angle of incidence (AOI) of the light beam at the filter. For example, filter 202 could be a thin film interference filter (TFF) or a Fabre-Perot filter. Detector 204 detects the output beam from filter 202, and provides an output signal 206 based on the detected beam.

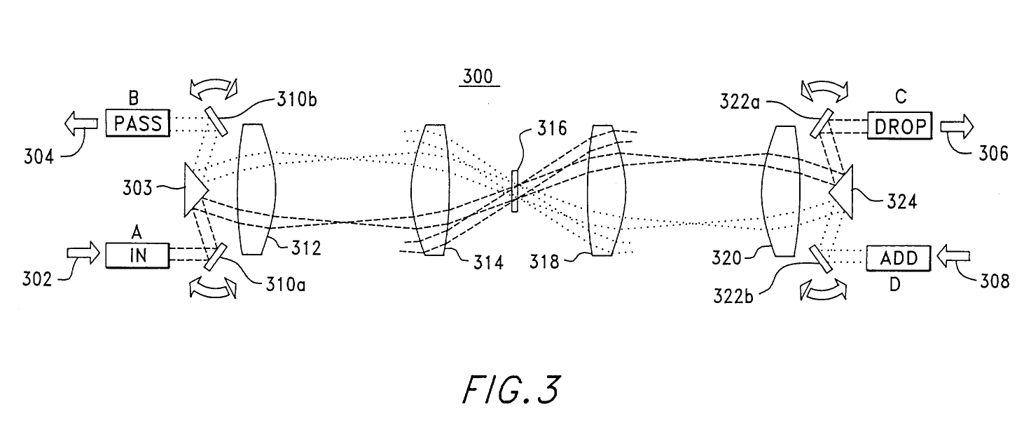

FIG. 3 is a side schematic view of a tunable add/drop filter 300 using two scan relays similar to scan relay 100 of FIG. 1. Add/drop filter 300 is suitable for use in wavelength-division multiplexed (WDM) optical networking. Add/drop filter 300 provides an input port A for input light 302 wavelengths.

Wavelengths 304 which are provided back to the system (passed) are reflected from filter 316 and appear at output port B. Signals which are removed from the system for local use (dropped) pass through filter 316 and appear at port C. Signals which are provided to the system (added) are input into port D, pass through filter 316, and form part of output signal 304. Ports A-D are generally collimators. Scan mirrors 310a, 310b, 322a and 322b must all be synchronized in order to maintain coupling among all of the ports A-D.

In use, input signal 302 passes through port A and reflects off of scan mirror 310a. Its path is shown as a dashed line, following the lower path to the left of filter element 316. From scan mirror 310a, the input light reflects off of wedge shaped fold mirror 303, through lenses 312 and 314, and is incident upon filter element 316. Portions (wavelengths) of input signal 302 which are to be passed reflect off of filter element 316, back through lenses 314 and 312, off mirrors 303 and 310b, to appear at output port B as pass signal 304. This passed signal travels the upper path to the left of filter 316 (dotted line).

Portions of input signal 302 which are to be diverted for local use (dropped) pass through filter element 316, lenses 318 and 320, and reflect off mirrors 324 and 322a to appear at drop port C as drop signal 306. This signal follows the upper path to the right of filter element 316 (dashed line).

A signal 308 that is to be added into the system is input at add port D. After reflecting off of mirrors 322b and 324, it passes through lenses 320 and 318, passes through filter 316, passes through lenses 314 and 312, reflects off mirrors 303 and 310b, and appears as part of output signal 304. Added signal 308 follows the lower path to the right of filter 316 and the upper path to the left of filter 316 (dotted lines).

The wavelengths destined to drop or pass are selected by rotating scan mirrors 310a, 310b, 322a and 322b. This is done not to change the path of the light, but rather to change the angle at which the light is incident upon filter 316. Since filter 316 is a narrow band filter tuned by the AOI of the incident light, this selects the wavelengths reflected and transmitted by the filter.

Those skilled in the art will appreciate that a drop filter could be constructed in a very similar manner, by simply removing the add port D and associated optics.

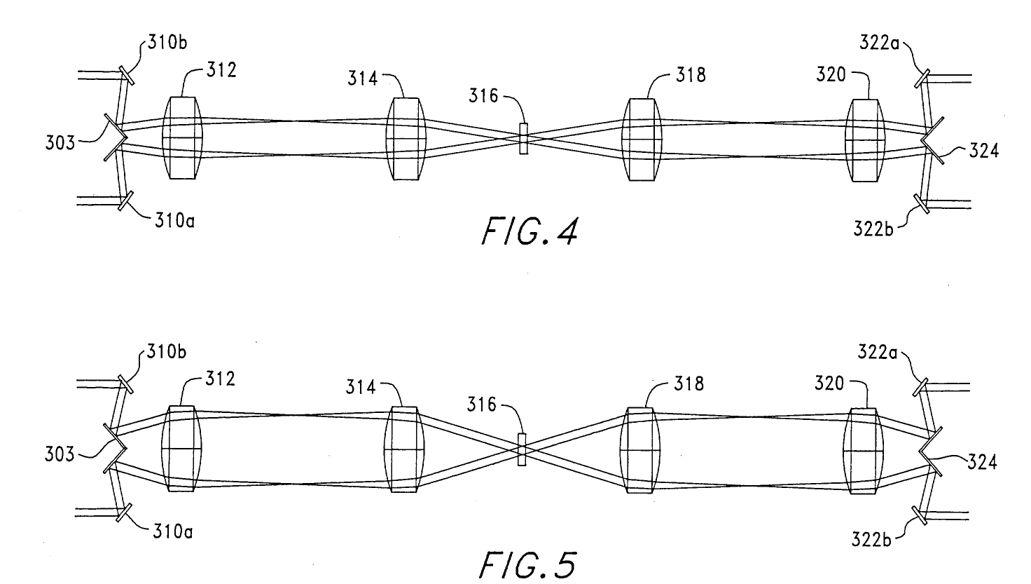

FIG. 4 is a side ray trace view of add/drop filter 300 of FIG. 3 configured to provide a relatively low angle of incidence (AOI) at filter element 316. In this configuration, scan mirrors 310a, 310b, 322a and 322b are rotated toward a plane perpendicular to the axis of the light. FIG. 5 is a side ray trace view of add/drop filter 300 of FIG. 3 configured to provide a relatively high AOI at the filter element. In this configuration, scan mirrors 310a, 310b, 322a and 322b are rotated toward a plane parallel to the axis of the light.

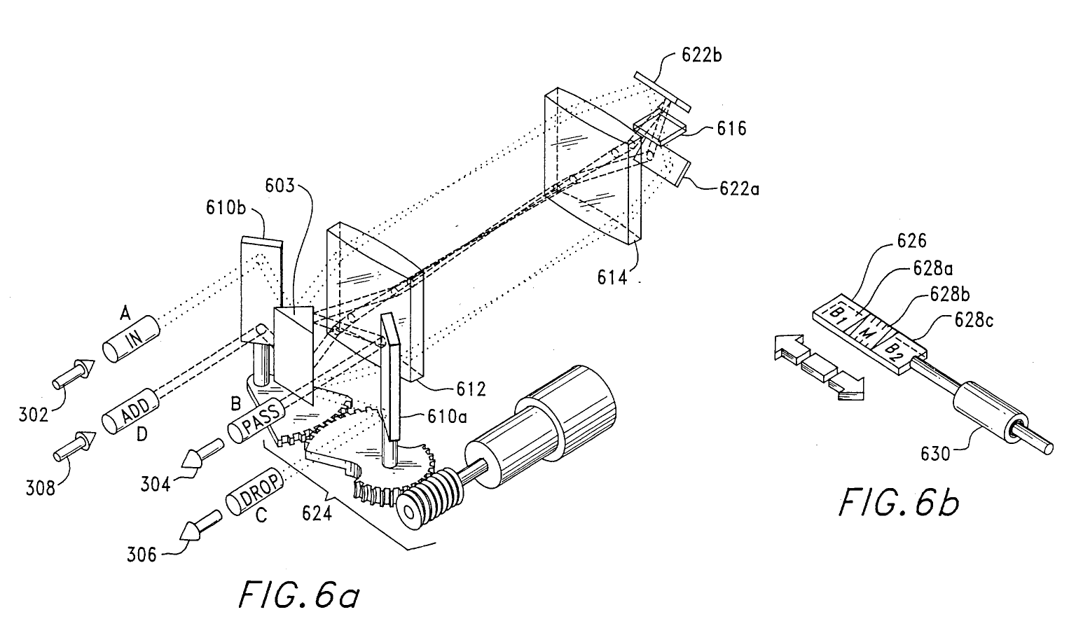

FIG. 6a is an isometric drawing of a preferred embodiment of add/drop filter similar in function to add/drop filter 300 of FIG. 3. In this embodiment, the scanning system has been folded by adding a pair of system fold mirrors, 622a and 622b, and by using cylindrical scan lenses 612 and 614 in place of scan lenses 312, 314, 318 and 320. Two spherical lenses stacked together could be used in place of a cylindrical lens. Hence, two scan relays are still used, but they utilize the same optical elements. The embodiment of FIG. 6a has several advantages. Only one set of scan mirrors 610a, 610b must be synchronously rotated, and hence a single rotating mechanism 624 may be used. In addition, all of the ports A-D are located in one area.

In use, input signal 302 passes through port A (a collimator) and reflects off of scan mirror 610b. Its path follows the upper left-hand path before filter element 316. From scan mirror 610b, the input light reflects off of wedge shaped fold mirror 603, passes through lenses 612 and 614, reflects off mirror 622b and is incident upon filter element 616. Portions (wavelengths) of input signal 302 which are to be passed reflect off of filter element 616 and mirror 622b, back through lenses 614 and 612, off mirrors 603 and 610a, to appear at output port B as pass signal 304. This passed signal travels the upper right-hand path after reflection off filter 616.

Portions of input signal 302 which are to be diverted for local use (dropped) pass through filter element 616, reflect off mirror 622a, pass through lenses 614 and 612, and reflect off mirrors 603 and 610a to appear at drop port C as drop signal 306. This signal follows the lower right-hand path. A signal 308 that is to be added into the system is input at add port D. It reflects off mirrors 610b and 603, passes through lenses 612 and 614, reflects off mirror 622b, passes through filter 616, reflects off mirror 622a, passes through lenses 614 and 612, reflects off mirrors 603 and 610a, and appears as part of output signal 304. Added signal 308 follows the central path, shown as a dashed line.

FIG. 6b is an isometric view of a variation on the embodiment of FIG. 6a wherein multiple filter panels 628 form a filter array 626 used in place of single filter element 616 of FIG. 6a. Linear actuator 630 moves filter array back and forth in order to locate the selected filter element 628a, b, c, etc., such that signal beams are incident upon it. Those skilled in the art will appreciate that a filter wheel with a rotating actuator, or a variety of other configurations and mechanisms, could be used to select which filter panel is used.

What is claimed is:

1. Optical filter apparatus for selectively passing or reflecting an input optical signal comprising:
a scan relay for selectively changing the angle of the input optical signal to form a scanned beam; and
a filter element of the kind tuned according the angle of incidence (AOI) of light incident on the filter element, the filter element positioned to intercept the scanned beam;
wherein the filter element does not rotate with respect to the axis of the input signal.

2. The apparatus of claim 1 wherein the scan relay comprises a rotating mirror positioned to intercept the input signal and two lenses positioned to pass the reflected beam.

3. The apparatus of claim 2 wherein the filter is a thin film interference filter (TFF).

4. The apparatus of claim 2 wherein the filter is a Fabry-Perot filter.

5. The apparatus of claim 1, further comprising a detector for detecting any light transmitted by the filter element, and for generating an output signal based on detected light.

6. An optical drop filter system of the type having an input port into which an input signal from a optical multiplexing system is transmitted, a pass port through which signals are returned to the system, and a drop port, through which signals are removed from the system, the drop filter system comprising:
a scan relay for selectively changing the angle of the input optical signal to form an input scanned beam;
a filter element of the kind tuned according the angle of incidence (AOI) of light incident on the filter element, the filter element positioned to intercept the input scanned beam and to transmit the input scanned beam or reflect the input scanned beam according to the wavelength of the input scanned beam; and
optics for directing any transmitted input scanned beam to the drop port;
wherein the first scan relay further directs the reflected input scanned beam to the pass port; and
wherein the filter element does not rotate with respect to the optical axis of the input signal.

7. The filter system of claim 6, wherein the optics for directing any transmitted input scanned beam comprise a second scan relay.

8. An optical add/drop filter system of the type having an input port into which an input signal from a optical multiplexing system is transmitted, a pass port through which signals to be returned to the system are transmitted, a drop port, through which signals are removed from the system, and an add port, via which an add signal is injected into the system, the add/drop filter comprising:
a first scan relay for selectively changing the angle of the input optical signal to form an input scanned beam;
a filter element of the kind tuned according the angle of incidence (AOI) of light incident on the filter element, the filter element positioned to intercept the scanned beam and to transmit the input scanned beam or reflect the input scanned beam according to the wavelength of the input scanned beam; and
a second scan relay for directing any transmitted input scanned beam to the drop port;
wherein the first scan relay further directs any reflected input scanned beam to the pass port;
wherein the second scan relay further selectively changes the angle of any add optical signal to form an add scanned beam;
wherein the filter transmits the add scanned beam according to its wavelength;
wherein the first scan relay further directs the transmitted add scanned beam to the pass port; and
wherein the filter element does not rotate with respect to the optical axis of the input signal.

9. The apparatus of claim 8, wherein the first scan relay and the second scan relay utilize the same optical elements.

10. The apparatus of claim 9, wherein the first scan relay and the second scan relay comprise two cylindrical scan lenses and five mirrors.

11. The apparatus of claim 8, wherein the filter comprises:
an array of filter panels; and
an actuator for selectively placing a filter array element in the path of the scanned beam.

11. A method for adding and dropping optical signals within an add/drop filter system having an input port into which an input signal from a optical multiplexing system is transmitted, a pass port through which signals to be returned to the system are transmitted, a drop port, through which signals are removed from the system, and an add port, via which an add signal is injected into the system, the method comprising the steps of:
selectively changing the angle of the input optical signal to form an input scanned beam;
filtering the input scanned beam to transmit the input scanned beam or reflect the input scanned beam according to the changed angle and according to the wavelength of the scanned beam;
directing any transmitted input scanned beam to the drop port;
directing any reflected input scanned beam to the pass port;
selectively changing the angle of any add optical signal to form an add scanned beam;
filtering the add scanned beam to either transmit the add scanned beam or to reflect the add scanned beam according to the changed add angle and according to the wavelength of the add scanned beam; and
directing the transmitted add scanned beam to the pass port.

12. The method of claim 7, wherein the filtering step further includes the step of selectively placing one filter element of an array of filter elements in the path of the scanned beam.
